(19) United States
(12) Patent Application Publication
(10) Pub. No.: US 2007/0234572 A1
(43) Pub. Date: Oct. 11, 2007

(54) Orbiting triple head electric shaver

(76) Inventors: Jeremiah Michael Hannan, San Rafael, CA (US); Gerald J. Hannan, San Rafael, CA (US)

Correspondence Address: JERRY HANNAN, 248 McNEAR DRIVE, SAN RAFAEL, CA, 94901, US

(21) Appl. No.: 11/397,367

(22) Filed: Apr. 5, 2006

(51) Int. Cl. B26B 19/02

(52) U.S. Cl. 30/43.92

(57) ABSTRACT

Rotary electric shavers having a plurality of planetary, rotating cutting heads

### SUMMARY OF THE INVENTION

The present invention arose as a result of the absence in prior art of a means of producing an orbiting or circular type motion of the cutter foils in an electric shaver with rotary cutting heads that are in planetary motion.

In current practice the cutter foils are stationary when the cutters are rotating. In the present invention the cutter foils can be engaged to produce an orbiting type of motion in the shaver head when the cutters are rotating and can be disengaged for use of the shaver in the conventional manner.

### NAMING PARTS

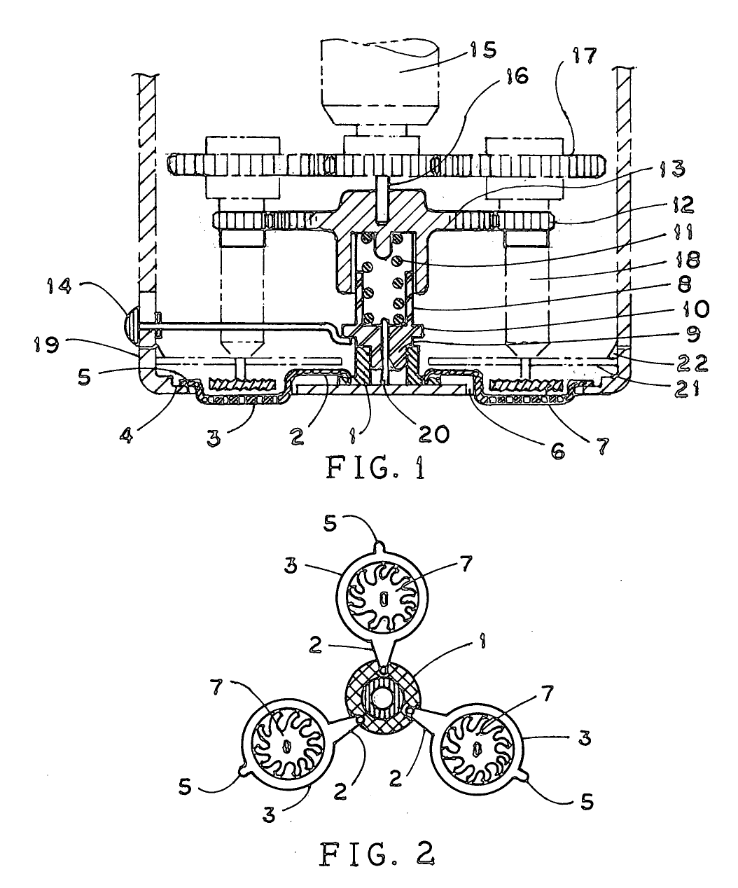

FIG. 1
(1) Bearing located in the center of the shaver head
(2) Connecting arms connecting foils to the bearing
(3) Foils
(4) Recess or groove in shaver head
(5) Extension arm on the foil
(6) Enlarged hole in shaver head
(7) Cutters mounted in the foils
(8) Center drive shaft
(9) Cam offset on center drive shaft
(10) Protruding ring on center drive shaft
(11) Spring to engage drive shaft to the bearing
(12) Small gears on drive shafts that rotate cutters
(13) Large reduction gear and hub on center drive shaft
(14) Lever to engage and disengage center drive shaft cam from the bearing
(15) Drive motor
(16) Drive motor shaft extension
(17) Gears connecting drive shafts and motor
(18) Drive shafts that rotate the cutters
(19) Shaver head or cover
(20) Steady pin fixed to shaver head
(21) Retainer to hold foils and cutters in the shaver head
(22) Clips to hold the retainer secure in the shaver head

FIG. 2
(1) Bearing
(2) Arms connecting the foils to the bearing
(5) Extension arm on the foil
(3) Foils underside view
(7) Cutters mounted in the foils

### NAMING PARTS

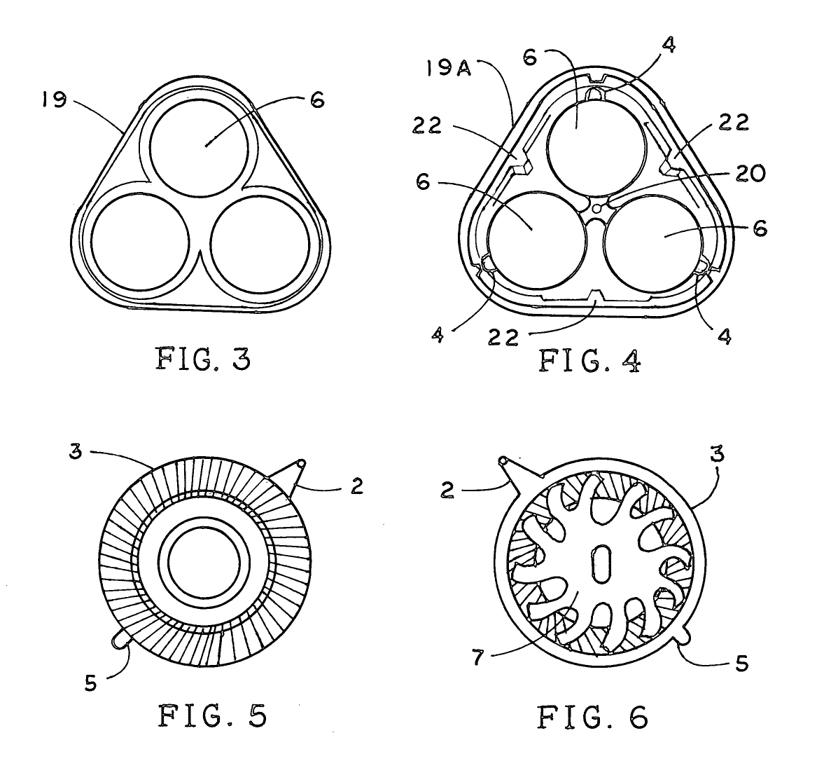

FIG. 3
(19) Shaver head or cover, top view
(6) Enlarged hole in shaver head

FIG. 4
(19A) Shaver head or cover, underside view
(4) Recess or grooves in shaver head
(6) Enlarged hole in shaver head
(20) Steady pin fixed to shaver head
(22) Clips to hold the retainer secure in the shaver head

FIG. 5
(2) Connecting arm connecting foil to the bearing
(3) Foil top view
(5) Extension arm on the foil

FIG. 6
(2) Connecting arm connecting foil to the bearing
(3) Foil and cutter underside view
(5) Extension arm on the foil
(6) Cutter mounted in the foil

### FIELD OF THE INVENTION

Rotary electric shavers having a plurality of planetary, rotating cutting heads

### SUMMARY OF THE INVENTION

The present invention arose as a result of the absence in prior art of a means of producing an circular or orbiting type motion of the cutter foils in an electric shaver with rotary cutting heads that are in planetary motion.

In current practice the cutter foils are stationary when the cutters are rotating. In the present invention the cutter foils can be engaged to produce an orbiting type of motion in the shaver head when the cutters are rotating and can be disengaged for use of the shaver in the conventional manner.

### SPECIFICATION FOR ORBITING TRIPLE HEAD ELECTRIC SHAVER

The subject of this patent application is an improved triple-head electric shaver. The orbiting electric shaver is made up of the following parts, namely, a drive motor, gears made of hard plastic or other suitable material to drive the shafts that connect to, and rotate the cutters. An additional drive shaft of hard plastic or other suitable material mounted in the center between the three drive shafts that rotate the cutters. A large gear on this center drive shaft connected to smaller gears on the three drive shafts. A bearing made of metal or other suitable hard material, located in the shaver head. Foils in the shaver head with connecting arms connecting the foils to the bearing A cam of metal or other suitable hard wearing material on the end of the center drive shaft that engages the bearing. A lever mounted in the shaver head or body to disengage the cam from the bearing. A spring in the center drive shaft to engage the cam to the bearing. Splines on the center drive shaft that mate with splines or grooves in its base. A modified retainer to hold the foils and cutters in place in the shaver head. All the parts used in this invention are constructed of suitable hard wearing materials including the foils, with the exception that the foils, and or the bearing surfaces on the shaver head that the foils make contact with, may use, or be coated with teflon or other friction reducing material to reduce friction between the orbiting foils and the shaver head.

The present invention relates to improvements in a triple head electric shaver and it consists in the combination, construction and arrangements of parts as hereinafter described and claimed.

The object of the invention is to provide a conventional electric shaver and add a center drive shaft to it to make the foils in the shaver head move in a circular or orbital type motion. This is accomplished by preferably connecting the foils to a small bearing installed in the shaver head. A cam, offset on the end of the rotating center shaft moves the bearing together with the attached foils in an orbital type motion in the shaver head. The links from the foils to the bearing are attached solidly to the foils and hinged to the bearing member thus allowing the foils to move in an orbital motion with ease in the shaver head. The orbiting rate of the foils in relation to the rotation of the cutters is much slower.

This is accomplished by use of a large reduction gear on the center drive shaft and smaller gears preferably mounted on the cutter drive shafts. Alternatively, grooved pulleys on the cutter drive shafts and a large grooved pulley on the center drive shaft together with one or more driving belts can be used instead of gears to rotate the center drive shaft.

It is possible if so desired, to further reduce the motion of the foils relative to the rotation speed of the cutters preferably with the use of additional gearing or drive belts and pulleys.

The operator can disengage the orbiting feature by means of a lever mounted in The shaver head or body. To engage the orbiting feature he merely moves the lever back to the original position allowing the spring to offer the cam back into the bearing. The rotating center shaft is preferably held on center on one end by the extended shaft from the drive motor and preferably by a steady pin at its other end mounted in the center of the shaver head. The operator therefore has the choice of using his shaver in the conventional fashion or engaging the orbiting feature for a faster and smoother shave.

To a better understanding of my invention, reference should be made to the accompanying drawings, forming part of this specification, in which:

FIG. 1 is a vertical section through an electric shaver and shows my center drive shaft (8) operatively applied thereto. The cam (9), is shown engaged in the bearing (1) which is linked to the foils (3) by means of connecting arms (2) on the foils. The small extension arms (5) on the foils (3) fit in the grooves (4) in the shaver head. The enlarged hole (6) in the shaver head allows sufficient clearance for the orbital type motion of the foils (3) when the shaver is switched on and the cam (9) is engaged in the bearing (1) in the shaver head. (20) is the steady pin in the center of the shaver head that holds the drive shaft (8) rotating on its center line. The cam (9) is tapered for easy entry to the bearing (1) and is countersunk at its entry point for easy engagement over the steady pin (20)

FIG. 2 is an expanded view of the bearing (1) with the connecting arms (2) and the foils (3) with their extension arms (5) together with the cutters (7).

FIG. 3 is a top view of the shaver head (19) showing the enlarged hole (6)

FIG. 4 is an underside view (19A) of the shaver head showing the recess or grooves (4) the enlarged holes (6) the steady pin (20) and the clips (22) to hold the retainer secure in the shaver head.

FIG. 5 is a top view of the foil (3) connecting arm (2) and extension arm (5). FIG. 6 is an underside view of the foil (3) showing the connecting arm (2) and the extension arm (5) with the cutter (7) in place in the foil (3)

### DETAILED DESCRIPTION

In carrying out our invention I will describe the construction and operation of our improved Triple Head Electric Shaver. The drive motor (15) supplies the power, the motor is provided with a gear that connects to a gear assembly (17) to which are attached three drive shafts (18), (of which only two are shown in the drawing). Each of the three drive shafts are equipped with small gears (12) that connect to a large reduction gear and hub (13) on the center drive shaft (8). The center shaft (8) has splines on its outer surface that mate with inner splines in its hub. The center shaft (8) has the ability to slide up and down in its hub and remain in lock step to the rotating hub. The center shaft (8) is provided with an inner spring (11) that exerts a force downward against the base of the gear hub assembly (13) and upward against the cam end (9) of the center drive shaft (8) and vise versa. The drive motor shaft extension (16) of the drive motor (15) serves as an axle pin for the gear hub assembly (13).

The steady pin (20) in the center of the shaver head (19) acts as an axle pin for the end of the center drive shaft (8) that embodies the cam (9). The drive shaft (8) as part of its structure, has a ring (10) all around, and protruding out from it that allows the lever (14) to move it against the pressure of the spring (11) thus disengaging the cam (9) from the bearing (1). The retainer (21) that holds the cutters and foils in place in the shaver head has an opening in its center to accommodate the bearing (1) and is snapped into place in the shaver head (19) and secured there by the clips (22).

When the shaver is switched on the motor (15) sets the gears (17) in motion to rotate the drive shafts (18) and the cutters (7) in the foils (3). The small gears (12) on the drive shafts (18) engaged in the large reduction gear (13) rotate the center drive shaft (8). When the offset cam (9) on the center drive shaft (8) is engaged in the bearing (1) the rotating center drive shaft (8) together with its offset cam (9) causes the bearing (1) to move in a circular motion carrying with it the arms (2) that are attached to the foils (3) causing the foils (3) to move in an orbital type motion. To keep the foils (3) centered in the enlarged hole (6) in the shaver head (19) the small extension arms (5) on the foils (3) fit into the recess or groves (4) in the shaver head. The grooves (4) have sufficient clearance for the extension arms (5) to allow for the side to side and in and out movement of the extension arms (5) when the foils (3) to which they are attached are in their orbital type motion. The cam (9) is preferably offset from center on the drive shaft (8) approximately 0.5 mm or so.

When the orbiting feature is engaged, the orbiting foils (3) raises the beard for a closer, smoother, and faster shave.

For cleaning purposes the shaver head can be removed in the conventional fashion. When re-installing the shaver head, the steady pin (20) will comfortably enter the countersunk end of the cam (9)

While I have shown only the preferred form of our invention, it should be understood that various changes, or modifications, may be made within the scope of the annexed claims without departing from the scope thereof.

What I claim is:

1) The combination with a triple head electric shaver wherein the diameter of the holes in the shaver head are sufficiently larger than the diameters of the foils to permit the foils to move in an orbital or circular type motion within the holes of the shaver head

2) The combination with a triple head electric shaver including:
a bearing or member mounted in the shaver head to which the cutter foils are pivotally attached.

3) With reference to claim (2) the bearing or member mounted in the shaver head is free floating.

4) The combination with a triple head electric shaver including; a drive shaft connected to the foils that rotates slower than the shafts that rotate the cutters.

5) The drive shaft referred to in claim (4) is preferably mounted on rigid axle pins in the shaver body and in the shaver head and rotates on a fixed plane to eliminate wobble.

6) The drive shaft referred to in claim (4) is preferably geared to one or more of the three existing drive shafts in the shaver body.

7) The drive shaft referred to in claim (4) is preferably geared in a manner that provides for a slower rotation than that or the cutter drive shafts.

8) The drive shaft referred to in claim (4) has an offset cam on its end that engages the free floating bearing in the shaver head.

9) The free floating bearing referred in dependent claim (8) is held in place with a retaining clip that provides for the installation of the floating bearing.

10) A combination with a triple head electric shaver including means that provide for a circular or orbital type motion of the foils and cutters in the shaver head at a slower rate than that of the rotating speed of the cutters.

11) A combination with a triple head electric shaver including means for engaging and disengaging the orbital type motion of the foils and cutters in the shaver head.
